(19) United States
(12) Patent Application Publication
(10) Pub. No.: US 2010/0070650 A1
(43) Pub. Date: Mar. 18, 2010

(54) SMART JMS NETWORK STACK

(76) Inventors: Andrew MacGaffey, Carol Stream, IL (US); Peter Lankford, Chicago, IL (US)

Correspondence Address: Deborah Neville, P O Box 61063, Palo Alto, CA, 94306, US

(21) Appl. No.: 12/312,836

(22) PCT Filed: Nov. 29, 2007
(86) PCT No.: PCT/US07/24549

§ 371 Date: Jun. 1, 2009

Related U.S. Application Data
(60) Provisional application No. 60/872,395, filed on Dec. 2, 2006.

(51) Int. Cl. G06F 15/173

(52) U.S. Cl. 709/238

(57) ABSTRACT

In a client server network, the invention provides improved message routing, useful in sending a plurality of subscriber messages from a single Server published message. The invention provides all the benefits of TCP delivery with most of the efficiency of IP multicast delivery. The invention provides for a Controller associated in the Client Server communication, where the Controller effectively routes the Server message to subscribed Clients. The invention provides efficient distribution of streaming data to one or more consumers in a way that enables easy integration in consuming applications. The invention provides means to implement a Java Message Service (JMS) distribution adapter in hardware. The invention further provides for hardware implementation of various wire protocol transforms.

### RELATED APPLICATIONS

Priority is claimed from U.S. provisional application 60/872,395 filed Dec. 2, 2006 of the same title, by the same inventors.

### GOVERNMENT FUNDING

None

### BACKGROUND

Current approaches to distributing streaming data to consuming applications are not particularly efficient. Data distribution methods that rely on network adapters and network switches do not understand application-level addressing such as subjects or Topics. When delivering messages from a publisher to one or more subscribers in a publish-subscribe pattern, these methods must send either in a one-to-one fashion using TCP (Transmission Control Protocol) or in a one-to-many fashion using UDP (User Datagram Protocol) broadcast or multicast.

When using TCP, the Server must send the same message over the network multiple times: a separate transmission for each subscriber. Multiple write operations increase CPU utilization in the sender. It follows that the last subscriber must wait for messages to be sent to all other subscribers, and thus use of TCP increases average latency for message delivery and increases the overall network bandwidth consumed by the system.

When using UDP broadcast and multicast some improvements are realized but several shortcomings are introduced. Additional logic is required in the Client to filter out messages that are not of interest. Network interface cards filter out unneeded IP multicast addresses, but such filtering does not significantly reduce the logic requirement, since there is a limited set of IP multicast addresses, and since managing a granular mapping between multicast addresses and application-level addresses such as subjects or Topics is a prohibitively onerous administrative task.

Broadcast/multicast protocols are notoriously unreliable, and require additional logic in the Server and Client to recover lost messages. Moreover, broadcast/multicast protocols suffer from the “slow-consumer” bottleneck, in which a single Client can disrupt message delivery to the entire set of Clients by its inability to keep up with the message stream. This is not a problem with TCP, as the switch can buffer messages for a slow consumer, and when those buffers are exceeded, the switch drops the connection for that consumer, protecting all other consumers.

Furthermore, Clients in a broadcast/multicast network are anonymous, which means that identifying a Client and ensuring that only entitled Clients receive specific message streams (e.g., fee-liable data, confidential data) requires further logic in each Client. Anonymity also means that administering broadcast/multicast systems is more difficult than unicast systems, since it is difficult to determine where messages originate and where they are being consumed. All of the additional Server and Client software required for broadcast/multicast delivery decreases throughput, increases latency, and increases the cost of system management.

Previous methods also rely on Server software to convert in-memory data representations to wire protocols and Client software to convert wire protocols to in-memory representations that can be used in applications. While such an efficient wire protocol that is less computationally expensive to decompress than other JMS protocols, the conversion still reduces the CPU resources available to the application. What is needed is some conversion means that requires little or no CPU resources available to an application. What is needed is the best of TCP delivery and the efficiency of IP multicast delivery, without any of the drawbacks of either method.

### SUMMARY OF INVENTION

The invention taught herein meets at least all the abovementioned unmet needs. The invention provides efficient distribution of streaming data to one or more consumers in a way that enables easy integration in consuming applications. The invention provides a Point-to-point paradigm in hardware, such that the hardware is able to operate on names for data. The invention provides means to implement a Java Message Service (JMS) distribution adapter in hardware (field programmable gate array/FPGA, application specific integrated circuit/ASIC, etc.). The invention further provides for hardware implementation of various wire protocol transforms. The invention further provides a means to implement JMS client library in such a way as to integrate with HPC (high performance computing) interconnects and protocol-conversion hardware.

The invention provides all the benefits of TCP delivery with most of the efficiency of IP multicast delivery. Furthermore, it provides all the benefits as described in published applications WO 2007/109087; WO 2007/109086; and PCT/US/006426 (entitled System and Method for Integration of Streaming Data, JMS Provider with Plug-able Business Logic; and Content Aware Routing for Subscriptions of Streaming and Static Data, respectively) while delivering improved performance.

In one embodiment, the invention provides hardware acceleration by means of network adapter on server, working with COTS (commercial off the shelf) switches. An implementation of the Topic-aware network hardware (also referred to herein as “Controller”) is in a network adapter, such as a Network Interface Card or Host Channel Adapter, that is compatible with common network media (such as Ethernet switches, Infiniband switches, etc.). In this implementation, the Controller accepts a single message from the Server and publishes it point-to-point over the network medium to each Client subscribed to the Topic to which the message applies. A single server can utilize multiple network adapters to increase fanout capacity.

In an alternate embodiment, a network switch implements fanout logic, working with commercial off the shelf or proprietary network adapters. In this implementation of the Controller in a network switch, the Controller accepts a single message from the Server and delivers it to multiple Clients via one or more switching methods (route processors, interface processors, dedicated ASICs, etc.). This functionality is analogous to IP multicast but uses Topic subscription as the basis for message routing, rather than IP multicast groups.

The controller implements fan-out in publish scenarios; the server only has to write once, reducing server CPU load. Latency is reduced because the Controller is able to fan out messages much more quickly than can Server software. In the network switch implementation, CPU utilization is reduced on Client and Server because extra protocol layers are eliminated. The Server knows the identity of all endpoints for each message stream, enabling authentication and authorization without client-side software. Combinations of hardware/firmware/software and hardware/firmware-only system configurations provide flexibility while supporting ultra-low latency operating characteristics. Support for multiple Topic namespaces improves ease-of-use for applications and simplifies system management. For additional discussion of application and system management related to the invention described herein, one may see the following applications by the same authors: WO 2007/109087; WO 2007/109086; and PCT/US/006426 (entitled System and Method for Integration of Streaming Data, JMS Provider with Plug-able Business Logic; and Content Aware Routing for Subscriptions of Streaming and Static Data, respectively). The implementation of this invention in a network switch provides plus additional performance benefits because messages intended for multiple subscribers only pass once from the server to the switch. Latency is reduced further and Bandwidth utilization is reduced significantly

The embodiment with the switch implementation provides all the benefits of TCP delivery with all the efficiency of IP multicast delivery, without any of the drawbacks of either method.

In the embodiments taught herein, the widely accepted standard JMS (Java Message Service) is the API and naming convention used in the invention.

In another embodiment, the HPC interconnect implementation, CPU utilization is reduced on Client and Server because extra protocol layers are eliminated. The Server knows the identity of all endpoints for each message stream, enabling authentication and authorization without client-side software Combinations of hardware/firmware/software and hardware/firmware-only system configurations provide flexibility while supporting ultra-low latency operating characteristics Support for multiple Topic namespaces improves ease-of-use for applications and simplifies system management

### BRIEF DESCRIPTION OF THE DRAWINGS

FIG. 1 conceptually illustrates an embodiment of the invention (publisher model)

FIG. 2 conceptually illustrates an alternate embodiment of the inventions (Interconnect model)

FIG. 3 illustrates an application of the invention depicted in FIG. 2, in HPC

### DETAILED DESCRIPTION OF PREFERRED EMBODIMENT

Note: numbers used in the Figures are repeated when identifying the same elements in various embodiments.

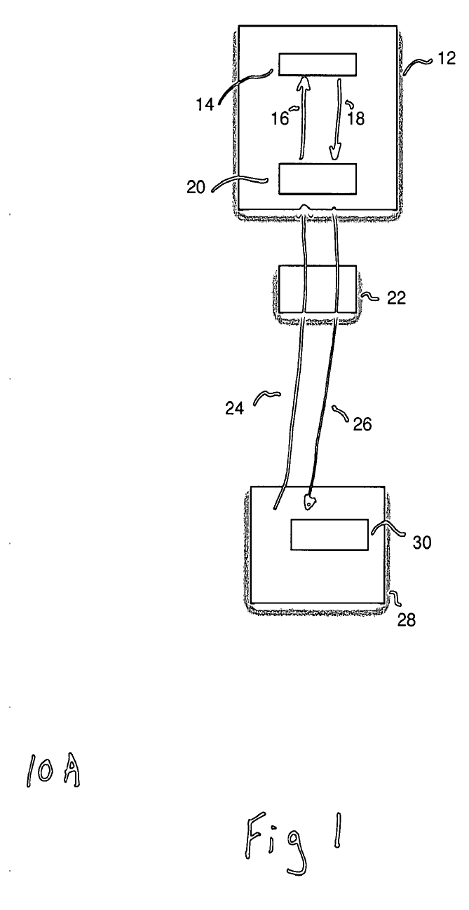

Referring to FIG. 1, one embodiment of the invention is graphically depicted. A server 12 with a server application 14 receives Topic open requests/initial value requests 16 from and transmits initial values/ updates 18 to a Controller 20. The Controller 20 by means of IP (Internet Protocol) and a switch 22 communicate to at least one Client application 28, where said Client application has an API, and transmits Topic subscriptions 24 to the Server and receive initial values and updates 26 in return.

The invention provides a Controller 20—Topic-aware network hardware—that implements interest-based message routing of Java Message Service (JMS) Topic messages between a server application (Server) and one or more client applications (Client). In the embodiment depicted in FIG. 1, the Controller is some type of network adapter containing logic to accomplish subscription management, including sufficient logic to perform at least all of the following: wire protocol conversion, subscription table maintenance, writing packets to each IP address, buffering. The server application 14 performs authentication, authorization, subscription acceptance, subscription notification to controller and message publication.

In the preferred embodiment, Clients (client application 28) use an implementation of the JMS API 30 (in any programming language, including but not limited to Java) to subscribe and publish messages on JMS Topics. The Controller primarily implements “fan-out” of messages published by a Server 12 to interested and eligible Clients. In the invention, the Server 22 writes the message to the Controller only once, and the Controller subsequently forwards the message to each Client.

The Controller supports multiple Topic namespaces so that Client applications interact with the Server to establish an “application context” that defines the Topic namespace being used. [a full description of application context may be found in publication WO2007/109087]. Clients subscribing to Topics with identical names in different namespaces may see different streams of messages. Likewise, Clients subscribing to different names in different namespaces may see identical streams of messages. The Controller, therefore, maintains a mapping between each application context/Topic combination and the Clients subscribed to each.

In the embodiment depicted in FIG. 1, the Controller 20 is implemented via a network adapter, such as a Network Interface Card or Host Channel Adapter, where such network adapter is compatible with common network media (such as Ethernet switches, Infiniband switches, etc.). In this implementation, the Controller accepts a single message from the Server and publishes it point-to-point over the network medium to each Client subscribed to the Topic to which the message applies. A single server can utilize multiple network adapters—multiple Controllers—to increase fanout capacity.

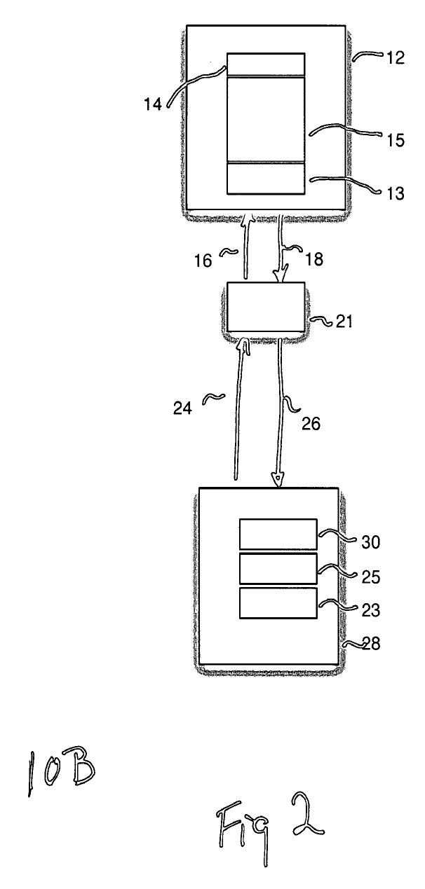

Referring to FIG. 2, an alternate embodiment 10B of the invention is graphically depicted, in which the Controller is implemented in a network switch. A server 12 with a server application 14, commercial off the shelf TCP/IP stack 15 and NIC 15, receives Topic open requests/initial value requests 16 from and transmits initial values/ updates 18 to a Controller 21 where the Controller is a switch containing logic sufficient to maintain subscription tables and perform “Topic to Client” routing. The Controller 21, by means of IP internet protocol, communicates with at least one Client application 28, where said Client application has an API 29, a commercial off the shelf TCP/IP stack 23, and an NIC 25, and transmits Topic subscriptions 24 to the Controller and receives initial values and updates 26 in return.

In this embodiment, the Controller 21 accepts a single message from the Server 12 and delivers it to one or more Clients via one or more switching methods (route processors, interface processors, dedicated ASICs, etc.). This functionality is analogous to IP multicast but uses Topic subscription as the basis for message routing, rather than IP multicast groups.

In this switch implementation embodiment 10B, the Controller 21 supports two simultaneous modes of interaction. The first is based on IP-standard addressing intended primarily for use with off-the-shelf network interface cards and software drivers. In this mode, all message routing is based on TCP/IP. The Server 12 publishes a message on a Topic by sending it to the switch/Controller 21 using TCP/IP; the switch/Controller 21 forwards the message to Clients, again, using TCP/IP.

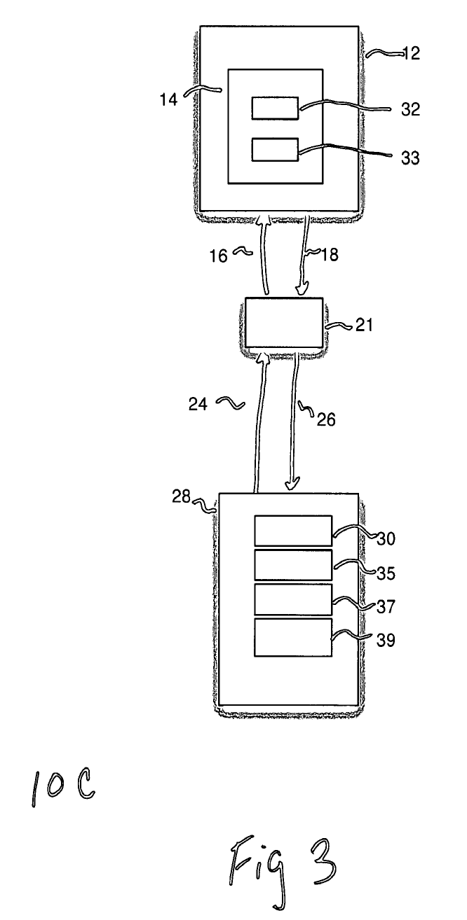

The second mode of interaction with the switch relies on specialized network hardware in the client and server, and is depicted FIG. 3. This embodiment 10C includes a Server proprietary NIC 33, and a Server HPC protocol based interconnect stack 32 also in the Server. The Client 28 has a Client proprietary NIC 39, a Client HPC protocol based interconnect stack 37, and System memory 35, in addition to the JMS API 30. In this embodiment, the Server and Client both use software drivers 32, 37 (Server and Client respectively) implementing a High-Performance Computing (HPC) interconnect such as the RDMA (Remote Direct Memory Access) protocol based on the JMS messaging model. In the Client, this driver logic is implemented in the JMS library. This mode eliminates the processing overhead associated with the TCP/IP stack.

For implementations based on an HPC interconnect, combinations of software drivers and one or more hardware network adapter devices that implement the protocol, and, optionally, perform compression and decompression of JMS messages, particularly, but not exclusively, JMS MapMessages. Further discussion of the JMS API based on IP protocol drivers and JMS API based protocol drivers may be found in publication WO2007/109087; the current invention may be further appreciated in light of teachings therein.

User-space server components interact with the Controller using either IP or HPC interconnect protocols and associated drivers/hardware and function to: accept or reject client connections and authenticate clients as required; accept or reject client sessions and dynamically configure the switch's Topic routing table; manage “application contexts”, each comprising a Topic namespace and associated resources; accept or reject client subscribe/publish requests and manage the registration of client subscriptions within the Controller such that messages sent from the Server to Client applications can be delivered to subscribed Clients. This requires the Controller, with the aid of the Server, to maintain an association between Topics and subscribed Clients; publish data messages to destinations via the Controller—either directly to a specific subscriber or to all subscribers on a particular Topic; receive and process data messages from client applications.

Those of skill in the relevant art can appreciate the invention as providing load balancing capability and the ability to transparently “redirect” Topic subscriptions to other Topics in the same application context (effectively implementing an aliasing technique) or to Topics in other application contexts, perhaps serviced by other entities (e.g., additional servers).

The invention provides the ability to manage client connections, sessions, and subscription requests in a server while directly distributing message traffic via a hardware appliance. This invention in its various embodiments delivers a unique combination of flexibility and low-latency/high-throughput operating characteristics.

It can be appreciated the invention is useful in applications such as distribution of financial market data, including scenarios such as: Server comprised of data publishing components servicing client applications that subscribe, and perhaps publish, using a JMS API;

Server that provides authentication and authorization functions, dynamic switch configuration to enable mapping of subscription requests to firmware-based protocol converters; hybrid system configurations that support standard JMS messaging functions (e.g. transactions, guaranteed delivery, etc) as well as low-latency distribution of market data with hardware/firmware support.

The invention is also useful in other middleware applications requiring distribution of high message volumes and/or low latency. Examples include Radio Frequency ID (RFID) solutions, sensor-based solutions, military command-and-control, navigation, targeting, weapons control, and radar systems.

We claim:

1. In a client server network, wherein one or more Clients request subscription-based messages from at least one Servers, a message distribution system comprising:
at least one Server said Server including Server Application and at least one Controller implemented via a network adapter, in communication with server and server application;
at least one switch, and
at least one Client, said client including an API, operable to communicate with said Server, such that in operation said Server writes a single message, and said Controller implements routing of said server message to one or more eligible Clients.

2. The message distribution system as in claim 1, where the API is JMS.

3. The message distribution system as in claim 1 wherein the Controller is a network adapter compatible with commercially available network media such as Ethernet switches and Infiniband switches.

4. The message distribution system as in claim 1 wherein more than one Controller is associated with a Server, providing increased fan-out of messages to Clients.

5. In a client server network wherein one or more Clients request subscription-based messages from at least one Server, a message distribution system comprising:
at least one Server said Server including server application TCP/IP protocol stack, and a Network Interface Card (NIC),
at least one Controller containing logic sufficient to maintain subscription tables and perform Topic to Client routing; and
at least one Client, said Client including an API, TCP/IP protocol stack, and NIC operable to communicate with said Server though said Controller, such that said Controller receives Topics from Server via TCP/IP and said Controller, using TCP/IP, forwards said Topic to one or more eligible Clients.

6. The message distribution system as in claim 5, where the API is JMS.

7. The message distribution system as in claim 5, wherein the Controller is a switch operable to deliver a message from the Server by one or more switching methods, including route processors, interface processors, dedicated ASICs.

8. In a client server network wherein one or more Clients request subscription-based messages from at least one Server, a message distribution system comprising:
at least one Server said Server including server application, Server High Performance Computing (HPC) protocol based interconnect stack, and a Server proprietary NIC; at least one Controller containing logic sufficient to maintain subscription tables and perform Topic to Client routing; and
at least one Client, said Client including an API, Client proprietary NIC, a Client HPC protocol based interconnect stack, and System memory, said Client operable to communicate with said Server though said Controller, such that said Controller receives Topics from Server via HPC interconnects and said Controller forwards said Topics to one or more eligible Clients.

9. The message distribution system as in claim 8, where the API is JMS.
